(19) United States
(12) Patent Application Publication
(10) Pub. No.: US 2005/0116478 A1
(43) Pub. Date: Jun. 2, 2005

(54) Methods and systems for magnetic coupling of latch mechanisms

(75) Inventors: Nigel V. Spurr, Solihull (GB); Michael J. Shelley, Fauldhouse (GB); Richard T. Hayes, Motherwell (GB); William F. Eaton, Pearl City, IL (US); Hugh D. Gibson, Edinburgh (GB); Alex Crawford, East Kilbride (GB); Ajaykumar Valdhyanathan, Chennai (IN); Scott A. Vorwald, Lena, IL (US); Kenneth V. Bechtold, Freeport, IL (US); Curtis B. Johnson, Freeport, IL (US); Duncan S. Murchie, Crieff (GB); Daniel D. Kilker, University Park, FL (US); Abanni B. Maxwell, Rockford, IL (US); Patrick H. Shannon, Eskbank (GB); Gillian J. Madden, Bothwell (GB); Adrian T. Kettle, Swindon (GB)

Correspondence Address: INCYTE CORPORATION;EXPERIMENTAL STATION, ROUTE 141 & HENRY CLAY ROAD, BLDG. E336, WILMINGTON, DE, 19880, US

(73) Assignee: Honeywell International, Inc.

(21) Appl. No.: 10/726,899

(22) Filed: Dec. 2, 2003

(51) Int. Cl. E05C 17/56

(52) U.S. Cl. 292/251.5

(57) ABSTRACT

Latching systems and methods are disclosed herein. A latch mechanism includes one or more sealed areas and one or more unsealed areas thereof. Also, a magnetic coupling mechanism is provided for coupling motion between the sealed area and the unsealed area and vice versa. The magnetic coupling mechanism can be configured to include a permanent magnet which generates a magnetic field for coupling the motion from the unsealed area to the sealed area and vice versa. The magnetic coupling mechanism can also be configured to include an electromagnet for generating a magnetic field for coupling thereof.

### TECHNICAL FIELD

Embodiments are generally related to door latch assemblies, including door latching mechanisms utilized in automobiles and other vehicles. Embodiments are also related to magnetic coupling techniques and devices.

### BACKGROUND OF THE INVENTION

Latching mechanisms are utilized in a variety of commercial and industrial applications, such as automobiles, airplanes, trucks, and the like. For example, an automotive closure, such as a door for an automobile passenger compartment, is typically hinged to swing between open and closed positions and conventionally includes a door latch that is housed between inner and outer panels of the door. The door latch functions in a well-known manner to latch the door when it is closed and to lock the door in the closed position or to unlock and unlatch the door so that the door can be opened manually.

The door latch can be operated remotely from inside the passenger compartment by two distinct operators—a button or an electric switch that controls the locking function and a handle that controls the latching function. The door latch is also operated remotely from the exterior of the automobile by a handle or push button that controls the latching function. A second distinct exterior operator, such as a key lock cylinder, may also be provided to control the locking function, particularly in the case of a front vehicle door. Each operator is accessible outside the door structure and extends into the door structure where it is operatively connected to the door latch mechanism by a cable actuator assembly or linkage system located inside the door structure.

Vehicles, such as passenger cars, are therefore commonly equipped with individual door latch assemblies which secure respective passenger and driver side doors to the vehicle. Each door latch assembly is typically provided with manual release mechanisms or lever for unlatching the door latch from the inside and outside of the vehicle, e.g. respective inner and outer door handles. In addition, many vehicles also include an electrically controlled actuator for remotely locking and unlocking the door latches.

One of the problems inherent with conventional latching mechanisms is that it is difficult, but necessary, to seal an area of a vehicle door latch through which motion must pass to an unsealed area. Motion must be coupled in the sealed area to achieve motion in the unsealed area and vice versa. Conventional latching assemblies do not provide stability and efficiency in achieving such motion. It therefore believed that a need exists for improved methods and systems for achieving motion within a latching mechanism without the instability and inefficiency inherent with conventional latching devices.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for an improved latch mechanism.

It is another aspect of the present invention to provide for improved latching methods and systems for use in automobiles and other vehicles.

It is yet a further aspect of the present invention to provide for magnetic coupling of motion between sealed and unsealed areas in a vehicle door latch environment.

The aforementioned aspects of the invention and other objectives and advantages can now be achieved as described herein. Latching systems and methods are disclosed herein. A latch mechanism includes one or more sealed areas and one or more unsealed areas thereof. Also, a magnetic coupling mechanism is provided for coupling motion between the sealed area and the unsealed area and vice versa. The magnetic coupling mechanism can be configured to include a permanent magnet which generates a magnetic field for coupling the motion from the unsealed area to the sealed area and vice versa. The magnetic coupling mechanism can also be configured to include an electromagnet for generating a magnetic field for coupling thereof.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of a vehicle door mounted to a passenger vehicle in which a preferred embodiment of the present invention can be implemented; and

FIG. 2 illustrates a high-level block diagram of a system which can be implemented in accordance with a preferred embodiment of the present invention.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

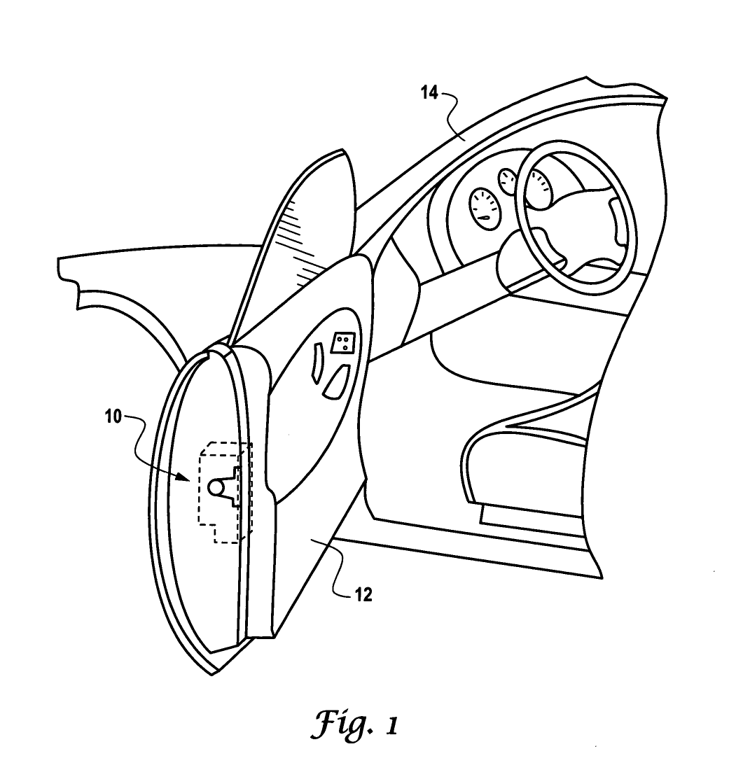

FIG. 1 illustrates a perspective view of a vehicle door 12 mounted to a passenger vehicle in which a preferred embodiment of the present invention can be implemented. A vehicle, such as an automobile can be equipped with one or more individual door latch assemblies 10, which secure respective passenger and driver side doors to the vehicle 14. Each door latch assembly 10 is typically provided with manual release mechanisms or lever for unlatching the door latch from the inside and outside of the vehicle, e.g. respective inner and outer door handles.

In addition, many vehicles can also be equipped with electrically controlled actuators for remotely locking and unlocking the door latches. As indicated in FIG. 1, a door latch assembly 10 can be mounted to a driver's side vehicle door 12 of a passenger vehicle 14. The door latch assembly 10 may be mounted to front and rear passenger side doors thereof and may be incorporated into a sliding side door, rear door, a rear hatch or a lift gate thereof, depending upon design constraints.

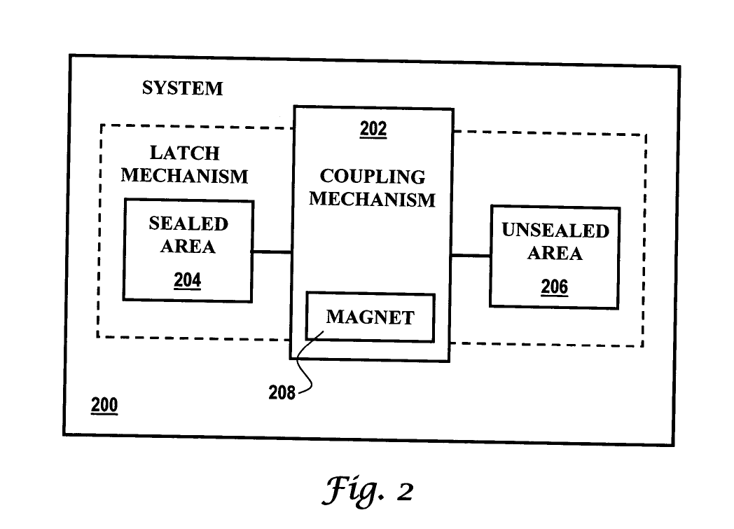

FIG. 2 illustrates a high-level block diagram of a system 200, which can be implemented in accordance with a preferred embodiment of the present invention. System 200 generally includes a latch mechanism 210 having at least one sealed area 204 and at least one unsealed area 206 thereof. System 210 also includes a magnetic coupling mechanism 202 for coupling motion between said sealed area 204 and unsealed area 206 and vice versa. Magnetic coupling mechanism 202 can be configured to include a magnet 208, which can be implemented as a permanent magnet or an electromagnetic to generate respective permanent or electromagnetic fields to couple motion in sealed area 204 to achieve motion in unsealed area 206 and vice versa.

System 200 thus permits sealing of a vehicle door latch, such as the door latch assembly 10 depicted in FIG. 1 through which motion must pass to an unsealed area thereof. It can be appreciated that coupling mechanism 202 can be configured to comprise one or more shafts (i.e., a single shaft or a plurality of shafts) coupled to the magnetic coupling mechanism for engaging sealed area 204 with the unsealed area 206. Such shafts can be integrated with the coupling mechanism 202. System 200 can be implemented in the context of latch assembly 10 of FIG. 1. For example, latch mechanism 210 of system 200 can be implemented as an assembly similar to latch assembly 10 of FIG. 1, but which includes one or more sealed areas 204 and one or more unsealed areas 206.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

1. A latch system, comprising:
a latch mechanism having and containing at least one sealed area and at least one unsealed area thereof; and
a magnetic coupling mechanism for coupling motion between said at least one sealed area and said at least one unsealed area and vice versa.

2. The system of claim 1 wherein said magnetic coupling mechanism comprises at least one permanent magnet, which generates a magnetic field for coupling said motion from said unsealed area to said sealed area and vice versa.

3. The system of claim 1 wherein said magnetic coupling mechanism comprises at least one electromagnet for generating a magnetic field for coupling motion between said at least one sealed area and said at least one unsealed area and vice versa.

4. The system of claim 1 wherein said latch mechanism comprises a door latch mechanism for respectively latching and unlatching a door open and closed.

5. The system of claim 4 wherein said door latch mechanism comprises a vehicle door latch mechanism.

6. The system of claim 5 wherein said door latch mechanism comprises a vehicle door latch mechanism for an automobile.

7. The system of claim 1 further comprising a shaft coupled to said magnetic coupling mechanism for engaging said sealed area with said unsealed area.

8. A latch system, comprising:
a latch mechanism having at least one sealed area and at least one unsealed area thereof; and
a magnetic coupling mechanism for coupling motion between said at least one sealed area and said at least one unsealed area and vice versa, wherein said magnetic coupling mechanism comprises at least one permanent magnet, which generates a magnetic field for coupling said motion from said unsealed area to said sealed area and vice versa.

9. The system of claim 8 wherein said latch mechanism comprises a door latch mechanism for respectively latching and unlatching a door open and closed.

10. The system of claim 9 wherein said door latch mechanism comprises a vehicle door latch mechanism.

11. The system of claim 10 wherein said door latch mechanism comprises a vehicle door latch mechanism for an automobile.

12. The system of claim 8 further comprising a shaft coupled to said magnetic coupling mechanism for engaging said sealed area with said unsealed area.

13. The system of claim 8 further comprising a plurality of shafts coupled to said magnetic coupling mechanism for engaging said sealed area with said unsealed area.

14. A latch method, comprising the steps of:
providing a latch mechanism having at least one sealed area and at least one unsealed area thereof; and
coupling motion between said at least one sealed area and said at least one unsealed area and vice versa utilizing a magnetic coupling mechanism.

15. The method of claim 14 further comprising the step of configuring said magnetic coupling mechanism to comprise at least one permanent magnet, which generates a magnetic field for coupling said motion from said unsealed area to said sealed area and vice versa.

16. The method of claim 14 further comprising the step of configuring said coupling mechanism to comprise at least one electromagnet for generating a magnetic field for coupling motion between said at least one sealed area and said at least one unsealed area and vice versa.

17. The method of claim 14 further comprising the step of configuring said latch mechanism to comprise a door latch mechanism for respectively latching and unlatching a door open and closed.

18. The method of claim 17 wherein said door latch mechanism comprises a vehicle door latch mechanism.

19. The method of claim 18 wherein said door latch mechanism comprises a vehicle door latch mechanism for an automobile.

20. The method of claim 14 further comprising the step of coupling a shaft to said magnetic coupling mechanism for engaging said sealed area with said unsealed area.

21. The method of claim 14 further comprising the step of coupling a plurality of shafts to said magnetic coupling mechanism for engaging said sealed area with said unsealed area.
